(19) United States
(12) Patent Application Publication
(10) Pub. No.: US 2019/0298490 A1
(43) Pub. Date: Oct. 3, 2019

(54) A SYRINGE FOR DISPENSING A DENTAL SUBSTANCE

(71) Applicant: 3M INNOVATIVE PROPERTIES COMPANY, St Paul, MI (US)

(72) Inventors: Andreas J. Boehm, Reichling (DE); Marc Peuker, Schoendorf (DE)

(21) Appl. No.: 16/092,310

(22) PCT Filed: Apr. 11, 2017
(86) PCT No.: PCT/US2017/026888

§ 371 Date: Oct. 9, 2018

(30) Foreign Application Priority Data
Apr. 13, 2016 (EP) 16165039.5

(51) Int. Cl. A61C 5/64; B05C 17/01

(52) U.S. Cl. CPC A61C 5/64; B05C 17/012

(57) ABSTRACT

A syringe (1) for dispensing a dental substance. The syringe has a container (11) that forms at least a first and a second component chamber (111, 112) and a plunger (12) having a first and a second plunger rod (121, 122). The first and second plunger rod (121, 122) are at least partially arranged in the first and second chambers, respectively, for a movement from a full position to an empty position over a displacement length. The syringe (1) further has an actuator (13) that is guided for a movement relative to the container (11). The movement of the actuator (13) is restricted for a predetermined actuation stroke being defined by a length between a rear position and a front position of the actuator (13). The plunger has a toothing and the teeth of the toothing are spaced at a pitch P. The actuator has at least a first pawl (139a) that meshes into the toothing of the plunger (12). The first pawl (139a) and the teeth of the toothing are configured such that in a movement of the actuator (13) in a direction from the front toward the rear position the pawl overrides the teeth and in a movement in the opposite direction the pawl engages the teeth. The displacement length is greater than the actuation stroke and the actuation stroke is at least twice of the pitch P. The syringe (1) allows for precisely dosed dispensing of multiple different portion of dental material.

### FIELD OF THE INVENTION

The invention relates to a syringe for dispensing a dental substance, and in particular to a syringe which can be operated in a stepwise manner.

### BACKGROUND ART

Dental materials are often stored in packages from which they can be directly dispensed to a desired location. For example the dental materials may be dispensed from the package on a pad or into a well and may be applied from there within a patient's mouth. In other situations the dental materials may be placed into a patient's mouth directly from such a package.

Dental materials further are often prepared from two or more components that are mixed together just before use. Often the individual components are obtained as portions from larger packages, for example from tubes, bags or cartridges. There are packages on the market that allow manual or automatic dispensing of two or more components at desired amounts and at an appropriate ratio for mixing. Furthermore there are packages that allow dispensation of portions of readily mixed materials from individually stored components.

Often double-barrel syringes are used for storing and mixing two-component dental materials. Such double-barrel syringes typically have two side by side tubular barrels from which the components of the dental material can be extruded by pushing pistons into the respective barrel. In one configuration of such a double-barrel syringe has D-shaped barrels which, arranged side by side, overall form one cylindrical structure as disclosed for example in U.S. Design Pat. No. 362,722.

Further, WO 2010/093575 discloses a syringe for dispensing a multi-component material. The syringe comprises a syringe cartridge having compartments for components of the multi-component material and a static mixer connected to the cartridge. The syringe further has a plunger assembly that is movable into the syringe cartridge to dispense material from the syringe.

There are further syringes that have a mechanism for alternative operation. Some syringes have a mechanism which operates based on a stepwise dispensation of the material. For example WO 2014/086559 A1 discloses a discharging device for a flowable component. The discharging device has a storage container with a storage chamber for accommodating the component, a filling opening and a discharging opening. The discharging device has a plunger which is arranged within the storage container and which is displaceable in an extension direction. Furthermore, the discharging device has an actuating element by means of which the plunger can be moved in a stepwise manner in the direction of the discharging opening. Further syringes having a stepwise operating mechanism are disclosed in U.S. Pat. No. 3,378,176 and FR 2 855 504.

Although there are a variety of syringes for dental use there is still a need for a syringe that is reliable and flexible in use, and nevertheless is relatively inexpensive. Such a syringe is desirably easy and convenient to use.

### SUMMARY OF THE INVENTION

The invention relates to a syringe for dispensing a dental substance. The syringe comprises a container that forms at least a first and a second component chamber. Each, the first and the second chamber extend in a dimension parallel to a longitudinal axis of the syringe. The syringe further comprises a plunger that comprises a first and a second plunger rod. The first and second plunger rod are at least partially arranged in the first and second chambers, respectively, for a movement from a full position to an empty position over a displacement length. The syringe has an actuator that is guided or restricted for a movement along the longitudinal axis relative to the container. The movement of the actuator is further restricted for a predetermined actuation stroke being defined by a length between a rear position and a front position of the actuator. The plunger further has a toothing along the dimension of the longitudinal axis. The teeth of the toothing are spaced at a pitch. The actuator comprises at least a first pawl that meshes into (or is adapted to engage) the toothing of the plunger. The first pawl and the teeth of the toothing are configured such that in a movement of the actuator in a direction from the front toward the rear position the pawl overrides the teeth and in a movement in the opposite direction the pawl engages the teeth. The displacement length is greater than the actuation stroke and the actuation stroke is at least twice of the pitch.

The invention is advantageous is that it provides a syringe that is convenient to use and that at the same time can be used for dispensing different predetermined amounts of material. In particular the invention is advantageous in that it allows for changing between the predetermined amounts of material by the same operation as the operation for dispensation. In particular the invention allows a user for dispensing the material by moving an actuator and by controlling the movement of the actuator the predetermined amount of material can be selected. Further the invention is advantageous in that it provides for a syringes that is relatively inexpensive.

The first and the second chamber preferably extend at a generally uniform cross-section in the dimension parallel to a longitudinal axis of the syringe. Preferably, the first and the second chamber are arranged side by side. The first and the second chamber may particularly extend at a D-profile. The D-profiles may be based on a container portion forming a generally cylindrical outer wall which inwardly is separated into the first and second chamber by a generally planar partition wall.

The first and second plunger rod are preferably fixedly connected to each other. Therefore, the plunger may have a connecting portion connecting the first and second plunger rod.

In an embodiment the plunger has a front portion formed adjacent a free end of the first and second plunger rod and an opposite rear portion. The first and second plunger rod are at least partially received within the first and second chamber, respectively, and wherein the rear portion of the plunger is arranged within the actuator. In particular, the free ends of each of the first and second plunger rod are preferably arranged within the first and second chamber, respectively. The connection portion preferably forms at last part of the plunger rear portion and may form a rear end of the plunger. Further, the free ends of the first and second plunger rod may form a front end of the plunger.

In a further embodiment the actuator guides the plunger in a movement along the longitudinal axis. The actuator may form a circumferential wall portion within which the rear portion of the plunger is received. The circumferential wall portion of the actuator preferably extends along the longitudinal axis and thus may guide or restrict the plunger. In particular, the actuator and the plunger are preferably joined for a telescopic movement relative to each other.

In an embodiment the plunger has an overall plunger length which is greater than the displacement length. Accordingly, in the empty position the plunger sticks out from a rear end of the container.

In a further embodiment each of the first and second plunger rod comprises a pair of toothings. The longitudinal axis preferably defines a first dimension of a Cartesian coordinate system. The first and second plunger rod are preferably arranged side by side with respect to the second dimension of the coordinate system. Further, the pair of toothings face in opposite directions of the third dimension of the coordinate system. The arrangement side by side with respect to the second dimension means that the first and second plunger rod extend generally parallel to each other and side by side or laterally of the longitudinal axis. Further, the first and second plunger rod preferably extend at a generally uniform cross-section, for example at a D-profile matching with the profile of the first and second chamber, respectively.

In a further embodiment the container has a front end which opens the first and second chamber, and an opposite rear end forming a finger plate. The front end of the container may form a front wall which forms a front end of the first and second chamber. In the empty position the front end of the plunger preferably is located at the front end of the first and second chamber. For example the plunger may abut the container front wall in the empty position. It is noted that the plunger is understood to abut the container front wall also if a non-displaceable thin film of dental material is still present between the plunger and the front wall. Such a thin film may have a thickness of less than 0.1 mm. Further, in the full position the front end of the plunger is preferably spaced from the front end of the first and the second chamber. Preferably, in the full position the plunger front end is arranged closer to the container rear end than to the container front end. More preferably, in the full position the plunger front end is arranged at less than 20% of a length of the container, and most preferably at less than 20% of a total length of the first and second chamber.

In an embodiment the syringe further has a guiding sleeve that is arranged at the rear end of the container. The guiding sleeve preferably guides the actuator, in particular for a movement in the longitudinal axis. The actuator is preferably partially received within the guiding sleeve. In particular, the actuator preferably sticks out from a rear end of the guiding sleeve. The rear end of the guiding sleeve is opposite of a front end of the guiding sleeve that is arranged at the container rear end.

In a further embodiment the actuator has a front end which is received within the sleeve and an opposite rear end. The actuator rear end forms a thrust plate which extends radially to the longitudinal axis at a dimension or diameter that is greater that the radial dimension or diameter of the sleeve. One of the actuator and the sleeve may have a latch and the other one of the actuator and the sleeve may have a stop. The latch may engage the stop in the rear position of the actuator and preventing a further movement of the actuator from the front position in a direction beyond the rear position. The stop may be formed by a wall of a recess (for example an elongated hole) formed in the guiding sleeve or the actuator, respectively. Thus, the actuator is restricted for the predetermined actuation stroke. The skilled person will recognize other solutions for permitting a movement of the actuator and the guiding sleeve along the longitudinal axis only over a predetermined length.

In a further embodiment the thrust plate and the finger plate are spaced at a first operation distance of between about 80 mm and about 60 mm in the rear position of the actuator and a second operation distance of between about 75 mm and about 55 mm in the front position of the actuator. It has been found that these operation distances allow for convenient operation of the syringe at maximized operation force. For the purpose of the present specification the operation distance is measured between the rear end of the actuator (free end of the thrust plate) and a surface of the finger plate oriented toward the front end of the syringe.

In a further embodiment the sleeve has a see-through area which permits at least the rear end of the plunger to be seen from outside the sleeve. Such a see-through area may be provided by a transparent or translucent material the guiding sleeve is made of, or a window or hole through the guiding sleeve. Therefore, a user may be indicated the remaining material still contained within the syringe.

In one embodiment the syringe further comprising a spring which is arranged for urging the actuator toward the rear position. The spring may particularly be arranged for acting between the guiding sleeve and the actuator, or for acting between the container and the actuator. The spring is preferably a compressing spring which by spring force urges the actuator toward the rear position. The spring may be a spiral spring, for example made of metal or a plastic material.

In a further embodiment the syringe further comprises a dispensing nozzle. The dispensing nozzle is preferably received on the container. Further, the dispensing nozzle and the container in combination may form a valve for opening and closing the first and second chamber. The dispensing nozzle preferably has a dispensing cannula which forms on outlet for the dental material. Preferably, the dispensing nozzle has an inlet for the two components, and the inlet is connected to the cannula. Thus, the dispensing nozzle provides for receiving the two components at the inlet, merging the components in the cannula and releasing the components from the outlet. The dispensing nozzle may further comprise a static mixer arranged at least partially within the cannula for mixing the two components as they flow through the dispensing nozzle.

### BRIEF DESCRIPTION OF THE FIGURES

FIG. 1 is a perspective view of a syringe according to an embodiment of the invention;

FIG. 2 is a perspective view of the syringe shown in FIG. 1 at a different stage of operation;

FIG. 3 is a cross-sectional view of a syringe according to an embodiment of the invention;

FIG. 4 illustrates the syringe of the invention at different stages of operation;

FIG. 5 is a cross-sectional view of a portion of the syringe according to an embodiment of the invention;

FIG. 6 is a cross-sectional view of a further portion of the syringe according to an embodiment of the invention; and

FIG. 7 is a diagram of the hand force dependent on the hand opening.

### DETAILED DESCRIPTION OF THE INVENTION

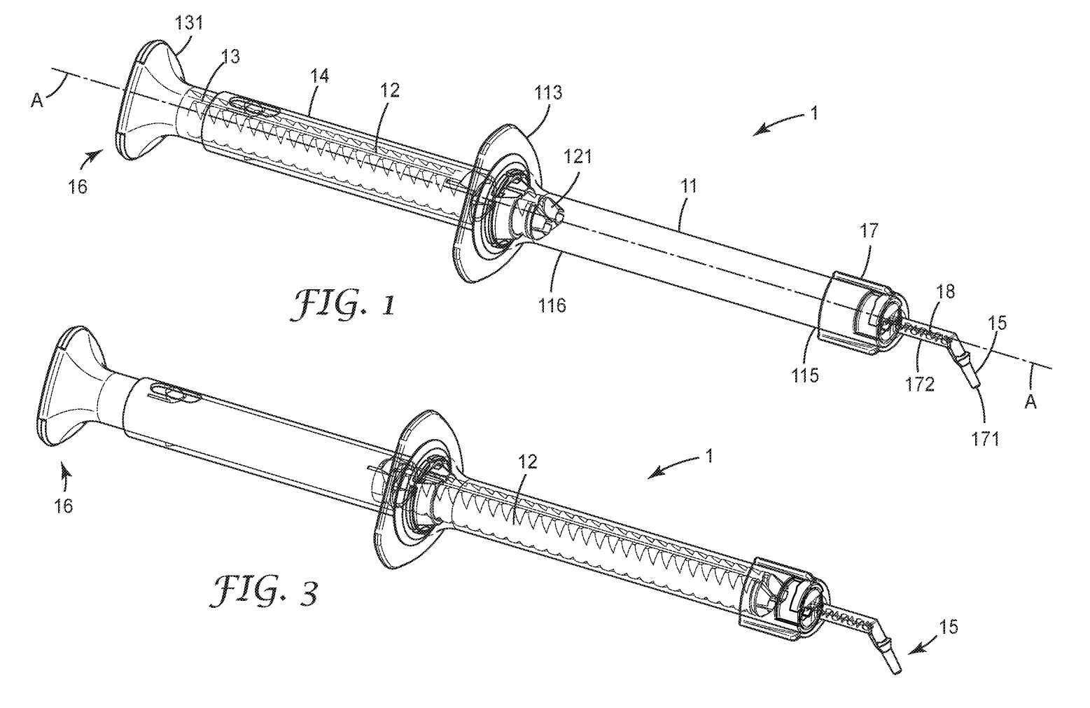

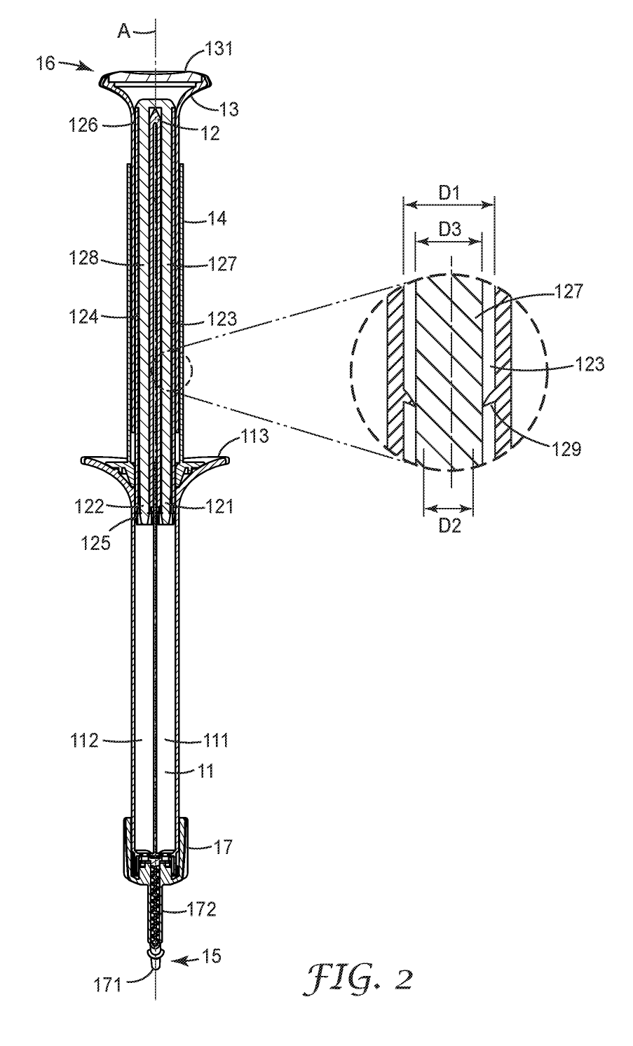

FIGS. 1 and 2 show a syringe 1 according to an embodiment of the invention. The syringe 1 extends along a longitudinal axis A and has a container 11 which forms (as indicated in FIG. 2) a first chamber 111 and a second chamber 112. The first and second chamber 111, 112 contain a dental material in the form of two components each stored in one of the first and second chamber 111, 112, respectively. Further, the syringe 1 has a plunger 12 which comprises a first plunger rod 121 and a second plunger rod 122 (see FIG. 2). The plunger 12 is partly accommodated within the actuator 13.

The syringe 1 further has an actuator 13 for stepwise moving the plunger 12 toward a front end 15 of the syringe 1. The actuator 13 is slidably accommodated within a guiding sleeve 14 which further guides the actuator 13 in a movement along the longitudinal axis A.

The syringe 1 further has a finger plate 113 and a thrust plate 131. The thrust plate 131 in the example forms a rear end 16 of the syringe 1. The finger plate 113 forms a rear end 116 of the container 11. The finger plate 113 and the thrust plate 131 enable a manual operation of the syringe 1 by a user for dispensing portions of the dental material from the to syringe 1.

The syringe 1 further has a nozzle 17 which is received on a front end 115 of the container 11. In particular the nozzle is rotatably attached on the container front end 115. The container 11 and the nozzle 17 in combination form a rotary slide valve for sealing the first and second chamber 111, 112 in a first position of the rotary slide valve and for establishing fluid communication between an outlet 171 of the nozzle 17 in a second position of the rotary slide valve. The first and second position of the rotary slide valve refer to two different angular positions of the nozzle 17 and the container 11 relative to each other about the longitudinal axis A. The nozzle 17 further comprises a cannula 172 in which in the example a static mixer 18 is accommodated. Thus, the two components are mixed as they are urged through the nozzle 17 so that the dental material exits the outlet 171 as a mixture from the two components.

FIGS. 1 and 2 illustrate the syringe 1 in a full position. In the full position the first and second chamber 111, 112 contains an amount of material which is sufficient for several dispensation strokes as further described in detail below. The full position may correspond to a situation in which the syringe 1 is still unused after delivery from the manufacturer of the syringe.

In the example the plunger 12 has a first and a second through-hole 123, 124 which each are sealed by a first and a second pin 127, 128, respectively. The first and second through-hole 123, 124 serve for placing the plunger 12 into the container 11 at a stage at which the first and second chamber 111, 112 are already filled with the two components. Such a stage typically exists during manufacturing and filling of the syringe 1, for example at the manufacturer. During placing the plunger 12 into the container 11 the first and second pin 127, 128 do not seal the first and second through-hole 123, 124. In particular, the first and second pin 127, 128 may be removed from the first and second through-hole 123, 124. Thus, the plunger 12 can be placed into the container 11 while air displaced by the plunger 12 from the container 11 can escape through the first and second through-holes 123, 124. Each through-hole 123,124 has a generally uniform major diameter D1 over its length and comprises each a constriction forming a smaller diameter D2. Each constriction D2 is formed by a deformable sealing lip 129. The deformable sealing lips are arranged adjacent a front end 125 of the plunger 12. For sealing the container 11 after the plunger 12 has been set to the desired position, the first and second pin 127, 128 can be pushed into first and a second through-hole 123, 124. Thereby, the sealing lips are elastically deformed by the respective pin 127, 128 so that the pins 127, 128 seal the through-holes 123, 124 of the plunger 12. The first and second pin 127, 128 each have a diameter D3. The diameter D3 is greater than the diameter D2. Therefore, the pins 127, 128 deform the respective sealing lip when pushed through, thus forming a tight seal with the sealing lip. Further, the diameter D1 of each of the through-holes 123, 124 is greater than the diameter D3 of each of the pins 127, 128. Therefore, a gap is formed between each of the first and second pin 127, 128 and the through-holes 123, 124. The plunger 12 is typically positioned in the container 11 such that each of the two components contained in the first and second chamber 111, 112 is displaced into the respective through-hole 123, 124 to a position between the constriction and a rear end 126 of the plunger. Thus, the first and second chamber 111, 112 is sealed substantially free of air. Further, any excess amount of a component from filling tolerances in the first or second chamber 111, 112 is stored in the gap formed between the through-holes 123, 124 and the pins 127, 128 behind the constriction with respect to the front end 125 of the plunger 12.

In contrast FIG. 3 shows the same syringe 1 as shown in FIGS. 1 and 2 but with the dental material extruded from the syringe 1. At the stage shown the plunger 12 is in the empty position. The empty position is an extreme position of the plunger from which a further movement in a direction from the rear end 16 toward the front end 15 is disabled.

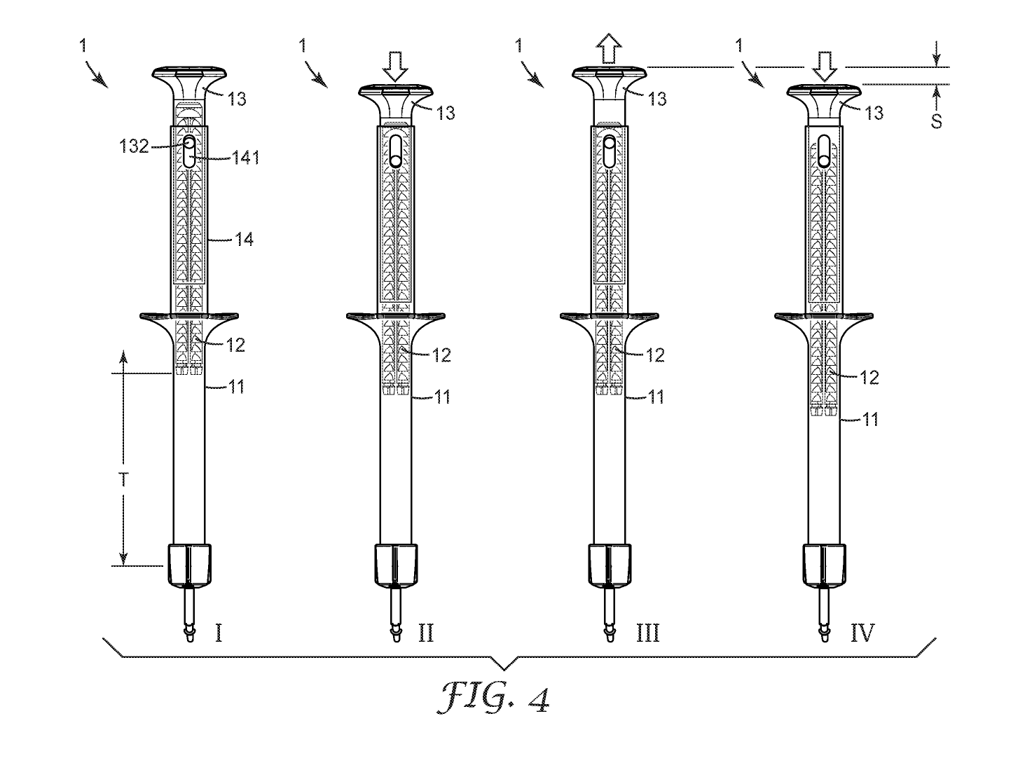

The operation of the syringe 1 is illustrated in FIG. 4 at different stages of operation I, II, III and IV. Stage I illustrates an initial stage in which the actuator is released. In the initial stage the actuator 13 is in a rear position with respect to the container 11. Stage II illustrates an actuated stage in which the actuator 13 is positioned in a front position with respect to the container 11. The actuator 13 is restricted for a movement between the rear and the front position as extreme positions.

In the example the restriction of the movement of the actuator 13 is provided by an elongated through-hole 141 and a latch 132 that is protruding into the elongated through-hole 141. The latch 132 is movable along the through-hole 141 and restricted by the through-hole 141 for a movement over only the length of the actuation stroke.

The actuated stage is typically reached in that a user pushes the actuator 13 relative to the container 11. Thereby, a pre-determined amount of dental material is dispensed. This is because the movement of the actuator 13 is restricted between the rear and the front position and because the actuator 13 is engaged with the piston 12 during the movement from the rear toward the front position. The engagement is such that a movement of the actuator 13 causes a movement of the plunger 12 by the same distance. The movement between the rear and the front position (and vice versa) is referred to herein as actuation stroke. The movement from the rear to the front position is referred to herein as forward stroke, and the movement from the front to the rear position is referred to as return stroke. Stage III illustrates the initial stage again. At this stage the actuator is reset from the front position to the rear position. The resetting is typically reached after the user releases the actuator 13, for example caused by spring force. During the return stroke the actuator and the plunger 12 are disengaged so that they can move relative to each other. Accordingly, the plunger 12 (being retained in the container 11 by friction) substantially does not move during the return stroke while the actuator 13 moves from the front to the rear position. Stage IV illustrates a stage after a further forward stroke. The actuation stroke has a length S. Accordingly, each forward stroke causes the plunger 12 to move by the distance S. Because the plunger 12 is movable over a displacement length T which is greater than the length S of the actuation stroke, the plunger 12 is only stepwise movable over the displacement length T. Therefore, the syringe 1 of the invention provides for dispensation of multiple predetermined amounts of dental material.

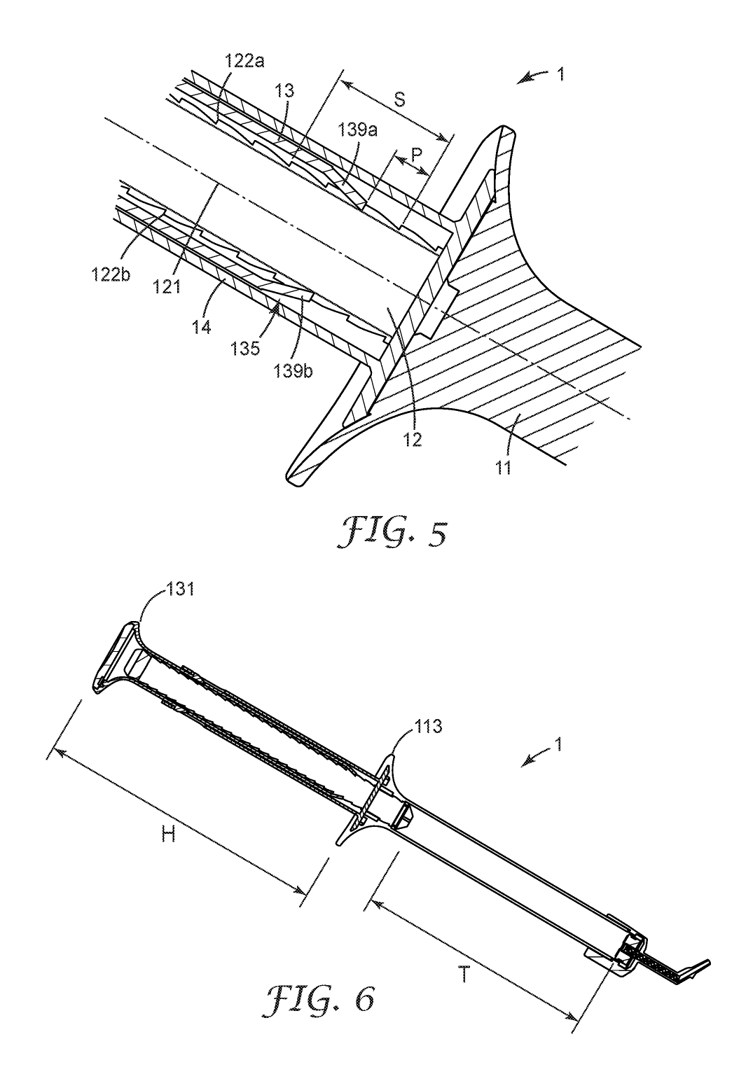

FIGS. 5 and 6 show detail views of the syringe 1. FIG. 5 shows a portion of the syringe 1 with the actuator 13, the guiding sleeve 14, the plunger 12 and the container 11. The plunger 12 has a first toothing 122a and a second toothing 122b. The first and second toothing 122a, 122b are facing in opposite directions. Further, first and second toothing 122a, 122b are arranged on the first plunger rod 121. The second plunger rod (hidden in this view) has a third and fourth toothing corresponding to the first and second toothing 122a, 122b. Accordingly, each plunger rod has a pair of toothings. The teeth of each of the first, second, third and fourth toothing are arranged at a pitch P.

In the following it is referred to the visible parts of the syringe, in particular the first plunger rod 122 with toothings 122a and 122b although the same teaching applied also for the second plunger rods with corresponding toothings.

The actuator 13 at a front end 135 forms a first and a second pawl 139a, 139b which mesh into the first and second toothings 122a, 122b, respectively. The toothings 122a, 122b have a saw-tooth profile in a plane parallel to the longitudinal axis A. The toothings 122a, 122b are configured so that in a forward stroke of the actuator 13 the pawls 139a, 139b engage a step flank (the steeper flank of a tooth in the saw-tooth profile) of the toothings. Further, in the reverse stroke of the actuator 13 the pawls 139a, 139b ride over one or more ramp flanks of the toothings. Accordingly, the actuator 13 entrains the plunger 12 in a forward stroke but moves relative to the plunger 12 in a return stroke.

The length S of the actuation stroke in the example is approximately three times of the pitch P. In other examples the length S of the actuation stroke is at least twice of the pitch P. Therefore, the syringe of the invention allows for dispensing multiple different pre-determined amounts of dental material. For example after a first full actuation stroke a user may stop the corresponding return stroke upon the pawls overriding a single tooth or two teeth only and start a new forward stroke from such a position. Overriding of a tooth of the toothing by the pawls typically causes an audible click upon the pawls snaps behind the step flank of the tooth. Therefore the user can recognize the position between the plunger and the actuator in a return stroke. In this way larger and smaller pre-determined amounts of dental material can be dispensed from the same syringe. For example, the user can dispense material by a full actuation stroke in which the actuator 13 is moved over the entire length between the rear position and the front position, or a partial actuation stroke in which the actuator 13 is moved only over the length of one or more pitches less than the length between the rear position and the front position. Each of the actuation strokes, either the full actuation strokes or the partial actuation strokes are referred to herein as dispensation strokes.

This is particularly useful in a dental treatment in which a base amount (full forward stroke) of material is typically required and in which smaller amounts (one or more partial forward strokes) need to be precisely added to complete the amount of material required for the individual clinical situation.

As indicated in FIG. 6 the displacement length T is a multiple of the length S of the actuation stroke and the length S of the actuation stroke is a multiple of the pitch P. In the example the ratio between T and S is 12:1 and the ratio between S and P is 3:1.

The syringe 1 is further configured such that the finger plate 113 and the thrust plate 131 are spaced at distance H in the rear position of the actuator 13. Further, the finger plate 113 and the thrust plate 131 are spaced at distance H−S (H minus S) in the front position of the actuator 13, whereby H−S is greater zero. Preferably, H−S is about between 80% to and 90% of H. Further, H is about between 80 mm and 50 mm.

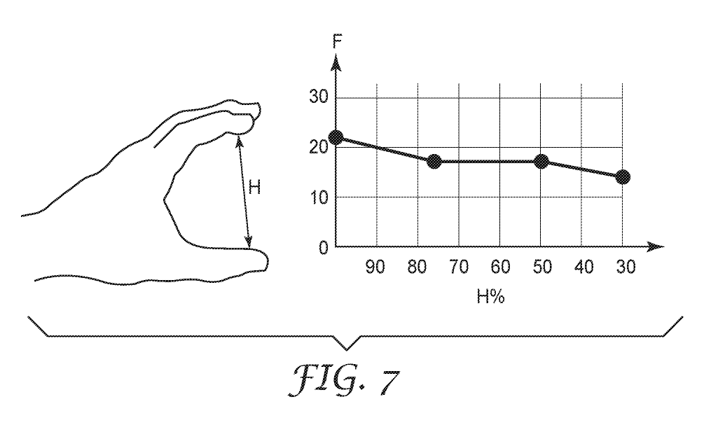

FIG. 7 shows on the left a full hand opening H which may correspond to the distance between the finger plate and the thrust plate of the syringe. As indicated in the diagram on the right a finger force F between the fingers and the thumb urged toward each other has a maximum at full hand opening and decreases toward smaller hand openings. Thus, the syringe being preferably adapted with the distance of the finger plate and the thrust plate to a typical hand opening can be operated relatively conveniently. Further, because the distance between the finger plate and the thrust plate is restricted between 100% and 80% of the distance H the syringe of the invention can be conveniently used over the full range of the displacement length T.

1. A syringe for dispensing a dental substance, comprising:
a container forming at least a first and a second component chamber that extend in a dimension parallel to a longitudinal axis of the syringe;
a plunger comprising a first and a second plunger rod;
the first and second plunger rod being at least partially arranged in the first and second chambers, respectively, for a movement from a full position to an empty position over a displacement length;
an actuator being guided for a movement along the longitudinal axis relative to the container, wherein the movement of the actuator is restricted for a predetermined actuation stroke being defined by a length between a rear position and a front position of the actuator;
wherein the plunger has a toothing along the dimension of the longitudinal axis, the teeth of the toothing being spaced at a pitch;
the actuator comprising at least a first pawl that meshes into the toothing of the plunger, wherein the first pawl and the teeth of the toothing are configured such that in a movement of the actuator in a direction from the front toward the rear position the pawl overrides the teeth and in a movement in the opposite direction the pawl engages the teeth;
wherein the displacement length is greater than the actuation stroke and the actuation stroke is at least twice of the pitch.

2. The syringe of claim 1, wherein the plunger has a front portion formed adjacent a free end of the first and second plunger rod and an opposite rear portion, wherein the first and second plunger rod are at least partially received within the first and second chamber, respectively, and wherein the rear portion of the plunger is arranged within the actuator.

3. The syringe of claim 2, wherein the actuator guides the plunger in a movement along the longitudinal axis.

4. The syringe of claim 1, wherein the plunger has an overall plunger length which is greater than the displacement length.

5. The syringe of claim 1, wherein each of the first and second plunger rod comprises a pair of toothings.

6. The syringe of claim 5, wherein the longitudinal axis defines a first dimension of a Cartesian coordinate system, the first and second plunger rod being arranged side by side with respect to a second dimension of the coordinate system, and wherein the pair of toothings face in opposite directions of the third dimension.

7. The syringe of claim 1, wherein the container has a front end which opens the first and second chamber, and an opposite rear end forming a finger plate.

8. The syringe of claim 7, further having a guiding sleeve being arranged at the container rear end and guiding the actuator that is partially received within the guiding sleeve.

9. The syringe of claim 8, wherein the actuator has a front end which is received within the guiding sleeve and an opposite rear end, the rear end forming a thrust plate which extends radially to the longitudinal axis at a dimension that is greater that the radial dimension of the guiding sleeve.

10. The syringe of claim 9, wherein one of the actuator and the guiding sleeve has a latch and the other one of the actuator and the guiding sleeve has a stop, wherein the latch engages the stop in the rear position of the actuator and preventing a further movement of the actuator from the front position in a direction beyond the rear position.

11. The syringe of claim 10, wherein the stop is formed by a wall of a recess formed in the guiding sleeve or the actuator, respectively.

12. The syringe of claim 7, wherein the thrust plate and the finger plate are spaced at a first operation distance of between about 80 mm and about 60 mm in the rear position of the actuator and a second operation distance of between about 75 mm and about 55 mm in the front position of the actuator.

13. The syringe of claim 7, wherein the sleeve has a see-through area permitting the rear end of the plunger to be seen from outside the sleeve.

14. The syringe of claim 1, further comprising a spring which is arranged for urging the actuator toward the rear position.

15. The syringe of claim 1, further comprising a dispensing nozzle that is received on the container, the dispensing nozzle and the container in combination forming a valve for opening and closing the first and second chamber.
